(19) United States
(12) Patent Application Publication
(10) Pub. No.: US 2025/0256772 A1
(43) Pub. Date: Aug. 14, 2025

(54) METHOD TO CONTROL A STEER-BY-WIRE STEERING SYSTEM OF A MOTOR VEHICLE WITH LIMITED FEEDBACK ACTUATOR OUTPUT TORQUE

(71) Applicants: Thyssenkrupp Presta AG, Eschen (LI); HONDA MOTOR CO., LTD., Tokyo (JP)

(72) Inventors: Munetsugu HANJI, Wako-shi (JP); Imre SZEPESSY, Mauren (LI); Takaya YAMAGUCHI, Wako-shi (JP); Yosuke OJIMA, Wako-shi (JP); Levente PÁSZTOR, Budapest (HU)

(21) Appl. No.: 19/194,390

(22) Filed: Apr. 30, 2025

Related U.S. Application Data
(63) Continuation of application No. PCT/EP2022/082521, filed on Nov. 19, 2022.

(51) Int. Cl. B62D 6/00; B62D 5/04

(52) U.S. Cl. CPC B62D 6/008; B62D 5/0484

(57) ABSTRACT

A method to control a steer-by-wire steering system of a road vehicle, the steer-by-wire steering system including a feedback actuator to apply a feedback torque to a steering wheel and a road wheel actuator to turn steerable road wheels, the method including calculating a feedback actuator output torque, and when degradation of the steer-by-wire-steering system occurs or an end of life of the steer-by-wire-steering system is detected, the feedback actuator output torque is limited by a limiter with a non-linear scaling function.

### CROSS REFERENCE TO RELATED APPLICATIONS

This application claims the benefit of priority to Continuation application of PCT Application No. PCT/EP2022/082521 filed on Nov. 19, 2022. The entire contents of this application are hereby incorporated herein by reference.

### BACKGROUND OF THE INVENTION

### 1. Field of the Invention

The present invention relates to methods to control steer-by-wire steering systems of motor vehicles and steer-by-wire steering systems configured or programmed to perform the method.

### 2. Description of the Related Art

In a steer-by-wire steering system, the vehicle's steering wheel is disengaged from the steering mechanism. In such a steering system, there is no mechanical coupling between the steering wheel and the steering gear. Steering movement is achieved by a steering actuator with an electric motor. The steering actuator operates in response to detected values of various steering parameters, such as steering wheel angle and vehicle speed, etc. The detected values are communicated electronically to the steering actuator from sensors, whereby the electric motor drives the rack and orients the steerable wheels in the desired direction.

One of the main requirements in steer-by-wire steering systems is that the steering system has to be fault tolerant, which means that if one failure occurs, the steering system has to operate further, providing the main functionality. If a malfunctioning in the system occurs, degradation might take place. Degradation of the system leads to limited function of the steering system. A limited function might include limited feedback actuator output torque.

It is known to linearly limit the feedback actuator output torque of the feedback actuator during degradation, which hardly influences the output of the feedback torque. It is also known that the gain of the feedback actuator output torque is limited, which can potentially lead to undesirable steering behavior. A simple solution of scaling down the overall steering feel to fit the remaining torque range after degradation has its disadvantages.

### SUMMARY OF THE INVENTION

Therefore, example embodiments of the present invention provide methods to control steering systems of road vehicles to allow feedback actuator torque output to be efficiently and drivably influenced during degradation.

According to an example embodiment of the present invention, a method to control a steer-by-wire steering system of a road vehicle is provided. The steer-by-wire steering system includes a feedback actuator to apply a feedback torque to a steering wheel and a road wheel actuator to turn steerable road wheels. The method includes calculating a feedback actuator output torque, and when degradation of the steer-by-wire-steering system occurs or an end of life of the steer-by-wire-steering system is detected, the feedback actuator output torque is reduced by a limiter with a non-linear scaling function, preferably only if the feedback actuator output torque is above a threshold.

The limitation creates an adequate steering feel and achieves improvement in the operability of the vehicle steering.

Preferably, the non-linear scaling function depends on the feedback actuator output torque value. A limitation of the limiter can increase non-linearly with increasing feedback actuator output torque value.

Preferably, the limited feedback actuator output torque increases monotonously with increasing feedback actuator output torque value.

It is preferred that below a threshold value, no limitation takes effect.

Preferably, above a second threshold, the limited feedback actuator output torque is a predefined maximum value.

Further it is preferred that the road vehicle speed is reduced in step b.

It is preferred that step b includes adjusting a nonlinear scaling function over time in a case of one side failure of the feedback actuator or adjusting the nonlinear scaling function according to a degree of degradation to further reduce the feedback actuator output torque.

Furthermore, a steer-by-wire steering system for a road vehicle configured or programmed to perform the method described above is provided.

The methods can be implemented in steering systems with a feedback actuator with only one side (redundant and non-redundant) or with two sides, where the method is implemented on one or both sides, or in steering systems with a special operation mode (for redundancy, e.g., specific/not usual steering feedback).

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic view of a steer-by-wire steering system.

FIG. 2 is a schematic diagram of a feedback actuator output torque plotted against steering wheel angle with a normal output curve and a limited output curve.

### DETAILED DESCRIPTION OF THE EXAMPLE EMBODIMENTS

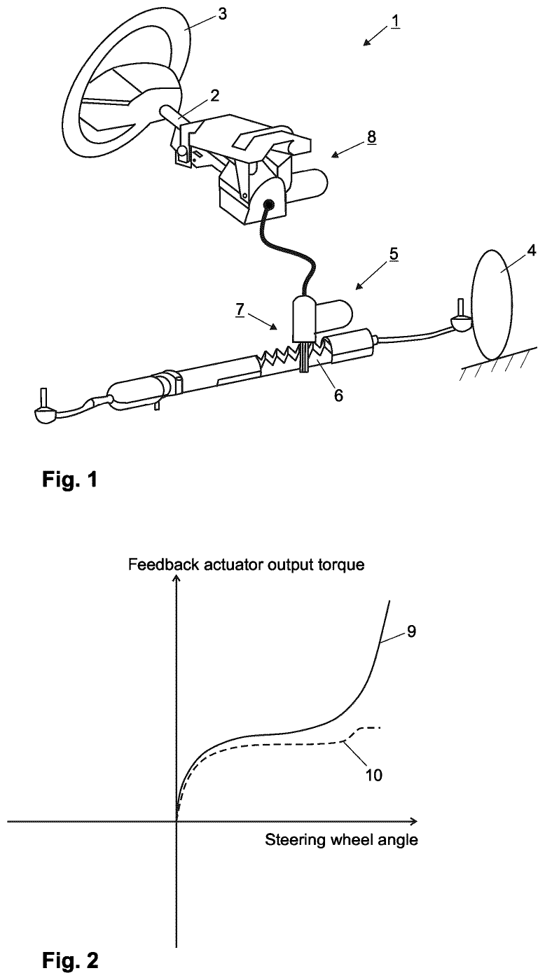

FIG. 1 is a schematic drawing of a steer-by-wire steering system 1 with a steering shaft 2 connected to a steering wheel 3. There is no mechanical connection between the steering wheel 3 and the road wheels 4. A road wheel actuator 5 operates a gear rack 6 via a rack-and-pinion gear 7.

When a driver operates the steering wheel 3, a steering shaft 2 is rotated, which is detected by a shaft sensor, which is not shown in the drawings. A controller is configured or programmed to calculate an operation signal for the road wheel actuator 5 from the signal detected by the shaft sensor. By operating gear rack 6 with the operation signal, the road wheels 4 are turned. At the same time, forces introduced in the gear rack 6 from the road wheels 4 are recognized by another sensor not shown in the drawings, and a feedback signal is calculated, which is applied to the steering shaft 2 by a steering wheel actuator 8, also called feedback actuator, so that the operator can recognize the feedback in the steering wheel 3. The feedback actuator is equipped with an ECU (electronic control unit) for the control of the feedback torque. The ECU determines a feedback actuator output torque on a requested amount of feedback torque and controls the feedback torque output of the feedback actuator based on the feedback actuator output torque. The feedback actuator output torque is calculated using vehicle and steering system related signals.

The relationship between the feedback actuator output torque and the steering wheel angle is shown in FIG. 2. The x-axis represents the steering wheel angle. The feedback actuator output torque is represented on the y-axis. The normal output curve 9 represented by the solid line rises sharply from the coordinate origin and then flattens out, becoming nearly horizontal before rising sharply again in a kind of hyperbolical progression. The shape is determined by a number of factors (e.g., the vehicle speed) and can differ a lot.

In a case of degradation due to malfunctioning in or of the system of the steer-by-wire steering system, especially degradation of the feedback actuator and/or the road wheel actuator, the feedback actuator output torque is limited by a limiter which includes a non-linear scaling function.

The feedback actuator output torque is multiplied by the non-linear scaling function, which depends on the feedback actuator output torque value. For small feedback actuator output torque values the feedback actuator output torque is not limited. Above a threshold value, limitation takes place in the form of a reduction of the feedback actuator output torque value. At medium values, the influence of the non-linear scaling function is moderate. At high values, the reduction is high and the feedback actuator output torque is limited by a predefined maximum value. In other words, the limitation increases non-linearly with increasing feedback actuator output torque value. The limited feedback actuator output torque can still be described by a monotonic function.

The dashed line represents the limited output curve 10. From the coordinate origin, the limited output curve rises sharply, but flatter than the normal output curve. After that, the limited output curve is also almost horizontal, below the normal output curve. In the area of the hyperbolic course of the normal output curve, the limited output curve rises slightly until a maximum value is reached, which corresponds to about half the value of feedback actuator output torque of the normal output curve. Generally speaking, the dashed line does not differ significantly from the solid line at low feedback actuator output torques, but the higher the feedback actuator output torque rises, the higher the deviation (=the intervention of the non-linear scaling function, the applied scaling) will be.

The method is advantageous for both single side feedback actuators and redundant feedback actuator architectures.

When degradation occurs and the limiter is activated with the non-linear scaling function, the vehicle speed preferably is also reduced so that the vehicle can be steered as intended by the driver.

The method can also be applied towards the end of life of the steer-by-wire steering system. Degradation of the actuator can happen at any time due to for instance drop of battery voltage or overheating of electrical components. The above described method provides a satisfactory steering feel, even if just a fraction of the nominal torque is available. The solution is independent of the root cause of the degradation. It is possible that the limitation will be increased over time.

The limited feedback actuator output torque preferably is dependent on the vehicle speed and steering speed (e.g., a damping and dynamic road wheel actuator degradation feedback function can be implemented).

During degradation, the method described results in lower power consumption, which helps maintain the steering system's ability to generate torque. However, over time, complete torque loss cannot be prevented. The nonlinear scaling function can be changed with time in case of one side failure of the feedback actuator. In the event of degradation due to a malfunction, the nonlinear scaling function can be changed according to the degree of degradation of the feedback actuator. This opens up the possibility of a more gradual loss of feedback actuator torque, which is safer because the driver has time to get used to the reduced torque feedback and eventually to the complete loss of torque feedback.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A method to control a steer-by-wire steering system of a road vehicle, the steer-by-wire steering system including a feedback actuator to apply a feedback torque to a steering wheel and a road wheel actuator to turn steerable road wheels, the method comprising:
a. calculating a feedback actuator output torque; and
b. when degradation of the steer-by-wire-steering system occurs or an end of life of the steer-by-wire-steering system is detected, limiting the feedback actuator output torque by a limiter with a non-linear scaling function.

2. The method according to claim 1, wherein in step b, the feedback actuator output torque is limited only if the feedback actuator output torque is above a first threshold.

3. The method according to claim 1, wherein the non-linear scaling function depends on the feedback actuator output torque value.

4. The method according to claim 3, wherein a limitation of the limiter increases non-linearly with increasing feedback actuator output torque.

5. The method according to claim 3, wherein the limited feedback actuator output torque increases monotonously with increasing steering wheel angle.

6. The method according to claim 1, wherein below a first threshold value, no limitation takes effect.

7. The method according to claim 1, wherein above a second threshold, the limited feedback actuator output torque is a predefined maximum value.

8. The method according to claim 1, wherein step b includes reducing a speed of the road vehicle.

9. The method according to claim 1, wherein step b includes adjusting a nonlinear scaling function over time in a case of one side failure of the feedback actuator or adjusting the nonlinear scaling function according to a degree of degradation to further reduce the feedback actuator output torque.

10. A steer-by-wire steering system for a road vehicle configured or programmed to carry out the method according to claim 1.
